(19) United States
(12) Patent Application Publication
(10) Pub. No.: US 2016/0091169 A1
(43) Pub. Date: Mar. 31, 2016

(54) LIGHT REFLECTING APPARATUS

(71) Applicant: PlayNitride Inc., Tainan City (TW)

(72) Inventor: Sheng-Yuan Sun, Tainan City (TW)

(21) Appl. No.: 14/830,749

(22) Filed: Aug. 20, 2015

(30) Foreign Application Priority Data
Sep. 25, 2014 (TW) 103133225

(51) Int. Cl. F21V 7/00; F21V 7/06; F21V 7/08; F21V 7/22

(52) U.S. Cl. CPC F21V 7/005; F21V 7/0033; F21V 7/22; F21V 7/06; F21V 7/08; F21Y 2103/00

(57) ABSTRACT

A light reflecting apparatus for reflecting a light beam generated from a light source is provided. The light reflecting apparatus includes a frame and two light reflecting elements. The frame has a bottom portion, two sidewall portions connected to the bottom portion, and at least one positioning structure located on each of the sidewall portions. The bottom portion and the two sidewall portions define an accommodation space. The linear light source is disposed on the bottom portion and located in the accommodation space. The at least one positioning structure located on each of the sidewall portions is located in the accommodation space. The light reflecting elements are located in the accommodation space, wherein each of the light reflecting elements is disposed between the bottom portion and the corresponding sidewall portion and contacts the at least one positioning structure located on the corresponding sidewall portion.

### CROSS-REFERENCE TO RELATED APPLICATION

This application claims the priority benefit of Taiwan application serial no. 103133225, filed on Sep. 25, 2014. The entirety of the above-mentioned patent application is hereby incorporated by reference herein and made a part of this specification.

### BACKGROUND OF THE DISCLOSURE

1. Field of the Disclosure

The disclosure relates to a light reflecting apparatus, and particularly relates to a light reflecting apparatus reflecting a light beam emitted from a light source.

2. Description of Related Art

The conventional linear light source module usually includes a light reflecting apparatus and a linear light source. The linear light source, for example, is formed by a plurality of light emitting elements that are linearly arranged and disposed in the light reflecting apparatus. Specifically, a portion of the light beams emitted by the linear light source is parallel to a main light axis of the linear light source and directly emitted, while another portion is emitted after being reflected by a light reflecting element of the light reflecting apparatus. The light beams reflected by the light reflecting element of the light reflecting apparatus may further include a portion that is parallel to the main light axis of the linear light source and emitted or another portion that is emitted intersecting the main light axis of the linear light source. In this way, the linear light source may have the light distribution as desired.

The convention light reflecting apparatus is usually formed by adhering the light reflecting element to a frame, and the frame is usually assembled by screw-locking a plurality of metal blocks and a plurality of metal bars. Before adhering the light reflecting element to the frame, the light reflecting element must be bent to exhibit a curvature as required based on the profile of some metal blocks, so that the profile of the bent light reflecting element may match the profile of the metal blocks and the light reflecting element is smoothly fit onto the metal blocks. However, there may be an assembly tolerance when the frame is assembled, and the assembly tolerance may make the curvature change of the light reflecting element not continuous, consequently affecting the effect of adjusting the light distribution.

### SUMMARY OF THE DISCLOSURE

The disclosure provides a light reflecting apparatus capable of adjusting a light distribution.

The disclosure provides a light reflecting apparatus reflecting a light beam emitted from a light source. The light reflecting apparatus includes a frame and two light reflecting elements. The frame has a bottom portion, two sidewall portions connected to the bottom portion and disposed opposite to each other, and at least one positioning structure located on each of the sidewall portions. The bottom portion and the sidewall portions define an accommodating space. The light source is disposed on the bottom portion and located in the accommodating space. The at least one positioning structure located on each of the sidewall portions is located in the accommodating space and the positioning structures are disposed opposite to each other. The light reflecting elements are located in the accommodating space. Each of the light reflecting elements is disposed between the bottom portion and the corresponding sidewall portion and contacts the at least one positioning structure located on the corresponding sidewall portion.

According to an embodiment of the disclosure, the light source is a linear light source formed by a plurality of linearly arranged light emitting elements.

According to an embodiment of the disclosure, the at least one positioning structure on each of the sidewall portions is a rib. An extending direction of the ribs is parallel to an extending direction of the linear light source.

According to an embodiment of the disclosure, the frame further includes two first slots located on the bottom portion and a second slot located on each of the sidewall portions. In addition, the at least one positioning structure located on each of the sidewall portions is located between the corresponding first slot and the corresponding second slot.

According to an embodiment of the disclosure, the first slots are located at two opposite sides of the linear light source.

According to an embodiment of the disclosure, an extending direction of the first slots and an extending direction of the second slots are parallel to an extending direction of the linear light source.

According to an embodiment of the disclosure, two ends of the light reflecting element are respectively located at the corresponding first slot and the corresponding second slot.

According to an embodiment of the disclosure, an orthogonal projection of the at least one positioning structure located on each of the sidewall portions on the bottom portion is located between the corresponding first slot and the corresponding sidewall portion.

According to an embodiment of the disclosure, the number of the at least one positioning structure on each of the sidewall portions is plural. A width of one of the positioning structures relatively close to the bottom portion is greater than a width of another of the positioning structures relatively away from the bottom portion.

According to an embodiment of the disclosure, widths of the positioning structures linearly decrease along a direction away from the bottom portion.

According to an embodiment of the disclosure, the frame is an aluminum-extrusion metal frame.

According to an embodiment of the disclosure, a material of each of the light reflecting elements includes aluminum, silver, or other materials having a reflective index over 90%.

According to an embodiment of the disclosure, each of the light reflecting elements located in the accommodating space forms a parabolic reflecting mirror, an ellipsoidal reflecting mirror, or other curved surface mirrors.

According to an embodiment of the disclosure, each of the light reflecting elements located in the accommodating space forms a flat reflecting mirror.

Based on above, after the light reflecting element is disposed at the bottom portion and the sidewall portion of the frame, the light reflecting apparatus of the disclosure is able to bend the light reflecting element through the structural interference between the positioning structure on the frame and the light reflecting element, so that the light reflecting element exhibits a specific curvature, thereby ensuring the continuity of the curvature change of the light reflecting element. In this way, the light beam emitted by the linear light source may be reflected by the light reflecting element to achieve a specific light distribution.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view illustrating a light reflecting apparatus according to an embodiment of the disclosure.

FIG. 2 is a schematic view illustrating a light reflecting apparatus according to another embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

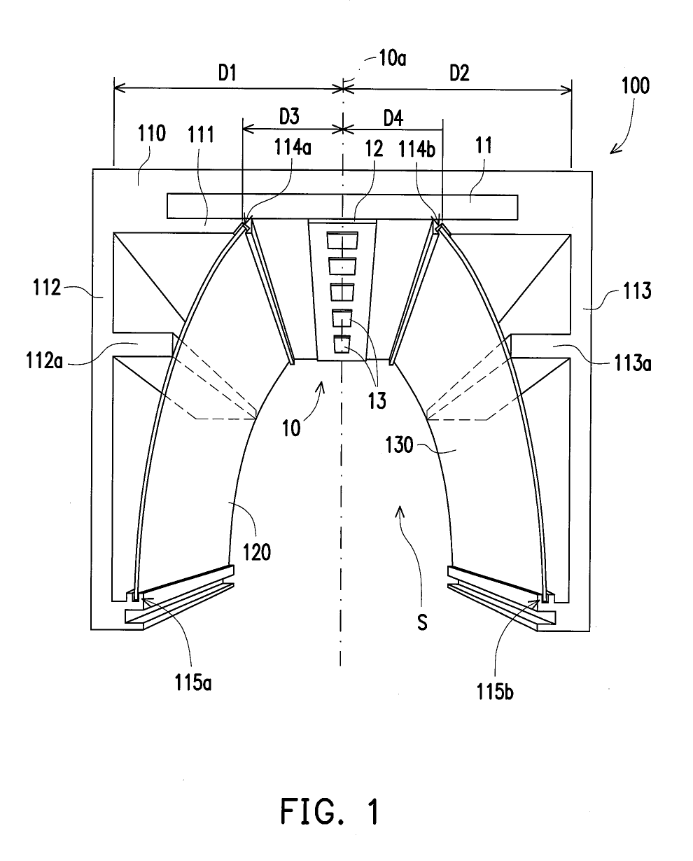

FIG. 1 is a schematic view illustrating a light reflecting apparatus according to an embodiment of the disclosure. Referring to FIG. 1, in this embodiment, a light reflecting apparatus 100 may reflect a light beam emitted from a light source 10. The light source 10 is a linear light source, for example, and includes a carrier 11, a circuit board 12 disposed on the carrier 11 and a plurality of light emitting elements 13 linearly arranged on the circuit board 12. Here, even though the light emitting elements 13 are described as being disposed on one single circuit board 12 as an example, the disclosure is not limited thereto. In other embodiments, a plurality of the circuit boards 12 may be disposed on the carrier 11, and each of the light emitting elements 13 may be individually disposed on the corresponding circuit board 12. Such arrangement is still an arrangement of a linear light source.

In general, the carrier 11 may be a heat-dissipating base formed of a metallic material, a ceramic material, or other suitable heat dissipating materials. Thus, the heat generated from the light emitting elements 13 when the light emitting elements 13 are being operated may be discharged to the external environment through the carrier 11. The circuit board 12 may be a FR-4 printed circuit board, a FR-5 printed circuit board, a silicon substrate, a ceramic substrate, or a metal substrate, and is fixed to the carrier 11 by adopting the surface mounting technology (SMT), for example. Besides, the light emitting elements 13 are electrically connected to a surface circuit layer (not shown) of the circuit board 12 with electrodes (not shown) of the light emitting elements 13 through flip chip bonding or by using a conductive adhesive.

The light reflecting apparatus 100 includes a frame 110, a first light reflecting element 120, and a second light reflecting element 130. The frame 110 is an aluminum-extrusion metal frame, and is preferably an integrally formed aluminum-extrusion metal frame. When the frame 110 is used with a linear light source, the manufacturing cost and time may be saved, and may have a preferable heat-dissipating effect. However, the disclosure is not limited thereto. The frame 110 has a bottom portion 111, a first sidewall portion 112, a second sidewall portion 113, a positioning structure 112a and a positioning structure 113a. The first sidewall portion 112 and the second sidewall portion 113 are connected to the bottom portion 111 and disposed opposite to each other. The positioning structure 112a is located on the first sidewall portion 112. The positioning structure 113a is located on the first sidewall portion 113. Specifically, the bottom portion 111, the first sidewall portion 112 and the second sidewall portion 113 may define an accommodating space S. In addition, the light source 10 is fixed at the bottom portion 111 of the frame 110 through the carrier 11, and is located in the accommodating space S, for example. Besides, the light source 10 has a main light axis 10a perpendicular an arrangement direction of the light emitting elements 13. In addition, a distance D1 between the main light axis 10a and the first sidewall portion 112 is substantially equal to a distance D2 between the main light axis 10a and the second sidewall portion 113. In other words, a cross-sectional profile of the frame 110 is substantially in a “∩” shape or a reversed U shape.

The positioning structure 112a located on the first sidewall portion 112 and the positioning structure 113a located on the second sidewall portion 113 are disposed opposite to each other and located in the accommodating space S. Here, the positioning structures 112a and 113a are ribs, for example, and an extending direction of the ribs are parallel to an extending direction of the light source 10, as shown in FIG. 1. Moreover, the frame 110 further includes slots 114a and 114b located on the bottom portion 111, a second slot 115a located on the first sidewall portion 112, and a second slot 115b located on the second sidewall portion 113. In addition, the positioning structure 112a is located between the first slot 114a and the second slot 115a, and the positioning structure 113a is located between the first slot 114b and the second slot 115b. From another perspective, the first slots 114a and 114b are symmetrically disposed at two sides of the light source 10, for example, and a distance D3 between the first slot 114a and the main light axis 10a is substantially equal to a distance D4 between the first slot 114b and the main light axis 10a. Furthermore, an extending direction of the first slots 114a and 114b and an extending direction of the second slots 115a and 115b are parallel to each other, and parallel to the extending direction of the light source 10, as shown in FIG. 1.

Here, materials of the first light reflecting element 120 and the second light reflecting element 130 may include metallic materials. Preferably, the materials of the first light reflecting element 120 and the second light reflecting element 130 are selected from aluminum, silver, or other materials with a reflective index over 90% and having a flexible property. Specifically, the first light reflecting element 120 and the second light reflecting element 130 are located in the accommodating space S. In addition, two ends of the first light reflecting element 120 are respectively located at the first slot 114a and the second slot 115a, and two ends of the second light reflecting element 130 are respectively located at the first slot 114b and the second slot 115b. In other words, with the first slot 114a and the second slot 115a, the first light reflecting element 120 may be disposed between the bottom portion 111 and the first sidewall portion 112. With the first slot 114b and the second slot 115b, the second light reflecting element 130 may be disposed between the bottom portion 111 and the second sidewall portion 113. In particular, the first slot 114a and the second slot 115a form rails on the frame 110, for example and openings of the first slot 114a and the second slot 115a face toward the accommodating space S, such that the first light reflecting element 120 and the second light reflecting element 130 may be fixed in the frame 110 by pushing.

To allow the first light reflecting element 120 and the second light reflecting element 130 to form a parabolic reflecting mirror, an ellipsoidal reflecting mirror, or other curved surface mirrors in the frame 110, when the two ends of the first light reflecting element 120 are respectively located at the first slot 114a and the second slot 115a, the first light reflecting element 120 may contact the positioning structure 112a located on the first sidewall portion 112. Since the orthogonal projection of the positioning structure 112a on the bottom portion 110 is located between the first slot 114a and the first sidewall portion 112 (i.e., a distance that the positioning structure 112a extends toward the light axis 10a does not exceed the location of the first slot 114a), in the corresponding configuration between the first slot 114a, the positioning structure 112a and the second slot 115a, the first light reflecting element 120 may be suitably bent to exhibit a specific curvature, so as to form a parabolic reflecting mirror, an ellipsoid reflecting mirror, or other curved surface mirrors.

Similarly, when the two ends of the second light reflecting element 130 are respectively located at the first slot 114b and the second slot 115b, the second light reflecting element 130 may contact the positioning structure 113a located on the second sidewall portion 113. Since the orthogonal projection of the positioning structure 113a on the bottom portion 110 is located between the first slot 114b and the second sidewall portion 113 (i.e., a distance that the positioning structure 113a extends toward the light axis 10a does not exceed the location of the first slot 114b), in the corresponding configuration between the first slot 114b, the positioning structure 113a, and the second slot 115b, the second light reflecting element 130 may be suitably bent to exhibit a specific curvature, so as to form a parabolic reflecting mirror, an ellipsoidal reflecting minor, or other curved surface minors. Here, the first light reflecting element 120 and the second light reflecting element 130 may be preferably formed as an ellipsoidal reflecting minor, such that the light source 10 may have a preferable concentrating effect in practice. Since the first slot 114a, the positioning structure 112a and the second slot 115a, as well as the first slot 114b, the positioning structure 113a and the second slot 115b are symmetrically disposed at two sides of the light axis 10a, the first light reflecting element 120 and the second light reflecting element 130 are also symmetrically disposed at two sides of the light axis 10a and exhibit the same curvature change. It should be noted that the first light reflecting element 120 and the second light reflecting element 130 may also form a flat reflecting mirror in the frame 110. With the rails formed by the first slot 114a and the second slot 115a on the frame 110, the first light reflecting element 120 and the second light reflecting element 130 may be fixed in the frame 110 by pushing, making the assembling more easily. To offer a preferable light concentrating effect, a minimum distance between the first light reflecting element 120 and the second light reflecting element 130 may be in a range from one time to five times of a maximum width of the light source 10.

In brief, with the structural interference caused between the internal structure of the frame 110 and the first and second light reflecting elements 120 and 130, the first light reflecting element 120 and the second light reflecting element 130 may be bent to exhibit a specific curvature, and the continuity and consistency of the curvature change is also ensured. In this way, the light beam emitted by the light source 10 may be reflected by the first light reflecting element 120 and the second light reflecting element 130 to achieve a specific light distribution.

In the following, other embodiments are provided for further description. It should be noted that the reference numerals and a part of the contents in the previous embodiment are used in the following embodiments, in which identical reference numerals indicate identical or similar components, and repeated description of the same technical contents is omitted. For a detailed description of the omitted parts, reference can be found in the previous embodiment, and no repeated description is contained in the following embodiments.

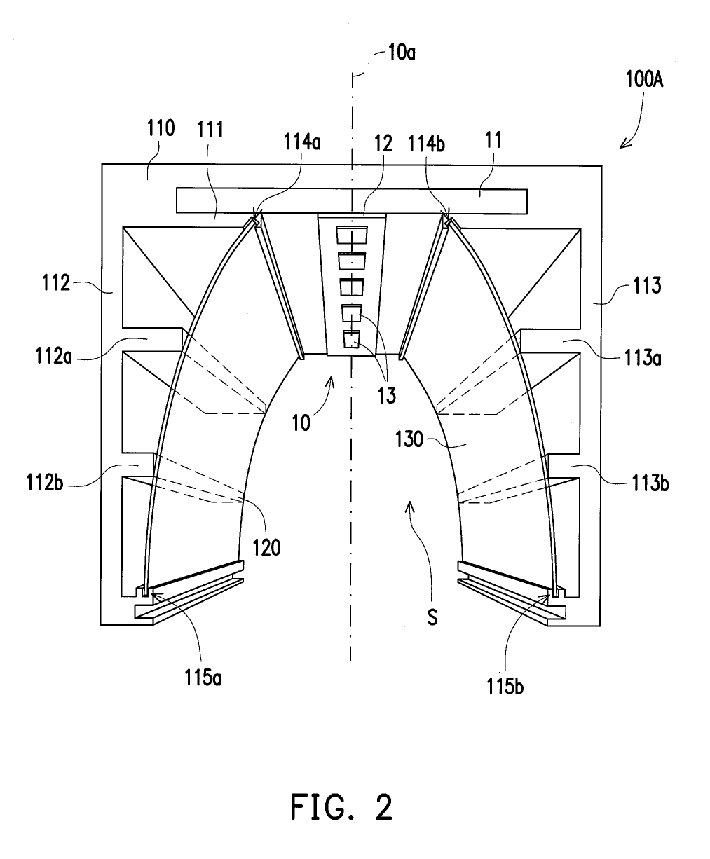

FIG. 2 is a schematic view illustrating a light reflecting apparatus according to another embodiment of the disclosure. Referring to FIG. 2, a light reflecting apparatus 100A is substantially similar to the light reflecting apparatus 100, except for a main difference that, in the light reflecting apparatus 100A of this embodiment, positioning structures 112a and 112b are disposed on the first sidewall portion 112, and positioning structures 113a and 113b are disposed on the second sidewall portion 113. Specifically, a width of the positioning structure 112a close to the bottom portion 110 is greater than a width of the positioning structure 112b of the bottom portion 110 away from the bottom portion 110. Similarly, a width of the positioning structure 113a close to the bottom portion 110 is also greater than a width of the positioning structure 113b away from the bottom portion 110. In other words, a plurality of position structures may be symmetrically disposed on the first sidewall portion 112 and the second sidewall portion 113. In addition, widths of the positioning structures may gradually decrease along a direction away from the bottom portion 110. Preferably, the gradual decrease is linear, such that the first light reflecting element 120 and the second light reflecting element 130 contacting the positioning structures may have a more precise design of curvature.

Accordingly, when the two ends of the first light reflecting element 120 are respectively located at the first slot 114a and the second slot 115a, the first light reflecting element 120 may simultaneously contact the positioning structures 112a and 112b on the first sidewall portion 112. Therefore, in the corresponding configuration between the first slot 114a, the positioning structures 112a and 112b, and the second slot 115a, the first light reflecting element 120 may be suitably bent to exhibit a specific curvature, so as to form a parabolic reflecting mirror, an ellipsoidal reflecting mirror, or other curved surface mirrors. Similarly, when the two ends of the second light reflecting element 130 are respectively located at the first slot 114b and the second slot 115b, the second light reflecting element 130 may contact the positioning structures 113a and 113b on the second sidewall portion 113. Therefore, in the corresponding configuration between the first slot 114a, the positioning structures 113a and 113b, and the second slot 115a, the second light reflecting element 130 may be suitably bent to exhibit a specific curvature, so as to form a parabolic reflecting mirror, an ellipsoidal reflecting mirror, or other curved surface mirrors.

Based on above, after the light reflecting element is fixed between the bottom portion and the sidewall portion, the light reflecting apparatus of the disclosure is able to bend the light reflecting element through the structural interference between the positioning structure on the frame and the light reflecting element, so that the light reflecting element exhibits a specific curvature, thereby ensuring the continuity of the curvature change of the light reflecting element. In this way, the light beam emitted by the linear light source may be converged and concentrated through reflection of the light reflecting element, thereby achieving a specific light distribution.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A light reflecting apparatus, reflecting a light beam emitted from a light source, the light reflecting apparatus comprising:
a frame, having a bottom portion, two sidewall portions connected to the bottom portion and disposed opposite to each other, and at least one positioning structure located on each of the sidewall portions, wherein the bottom portion and the sidewall portions define an accommodating space, the light source is disposed on the bottom portion and located in the accommodating space, and the at least one positioning structure located on each of the sidewall portions is located in the accommodating space and the positioning structures are disposed opposite to each other; and
two light reflecting elements, located in the accommodating space, wherein each of the light reflecting elements is disposed between the bottom portion and the corresponding sidewall portion and contacts the at least one positioning structure located on the corresponding sidewall portion.

2. The light reflecting apparatus as claimed in claim 1, wherein the light source is a linear light source formed by a plurality of linearly arranged light emitting elements.

3. The light reflecting apparatus as claimed in claim 2, wherein the at least one positioning structure located on each of the sidewall portions is a rib, and an extending direction of the ribs is parallel to an extending direction of the linear light source.

4. The light reflecting apparatus as claimed in claim 2, wherein the frame further comprises two first slots located on the bottom portion and a second slot located on each of the sidewall portions, wherein the at least one positioning structure located on each of the sidewall portions is located between the corresponding first slot and the corresponding second slot.

5. The light reflecting apparatus as claimed in claim 4, wherein the first slots are located at two opposite sides of the linear light source.

6. The light reflecting apparatus as claimed in claim 4, wherein an extending direction of the first slots and an extending direction of the second slots are parallel to the extending direction of the linear light source.

7. The light reflecting apparatus as claimed in claim 4, wherein two ends of each of the light reflecting elements are respectively located at the corresponding first slot and the corresponding second slot.

8. The light reflecting apparatus as claimed in claim 4, wherein an orthogonal projection of the at least one positioning structure located on each of the sidewall portions on the bottom portion is located between the corresponding first slot and the corresponding sidewall portion.

9. The light reflecting apparatus as claimed in claim 1, wherein the number of the at least one positioning structure on each of the sidewall portions is plural, and a width of one of the positioning structures relatively close to the bottom portion is greater than a width of another of the positioning structures relatively away from the bottom portion.

10. The light reflecting apparatus as claimed in claim 1, wherein widths of the positioning structures linearly decrease along a direction away from the bottom portion.

11. The light reflecting apparatus as claimed in claim 1, wherein the frame is an aluminum-extrusion metal frame.

12. The light reflecting apparatus as claimed in claim 1, wherein a material of each of the light reflecting elements comprises aluminum, silver, or other materials having a reflective index over 90%.

13. The light reflecting apparatus as claimed in claim 1, wherein each of the light reflecting elements located in the accommodating space forms a parabolic reflecting mirror, an ellipsoidal reflecting minor, or other curved surface mirrors.

14. The light reflecting apparatus as claimed in claim 1, wherein each of the light reflecting elements located in the accommodating space forms a flat reflecting minor.
